(19) United States
(12) Patent Application Publication
(10) Pub. No.: US 2026/0099356 A1
(43) Pub. Date: Apr. 9, 2026

(54) Distributed Concurrent Batch Processing

(71) Applicant: ServiceNow, Inc., Santa Clara, CA (US)

(72) Inventors: Vaibhav Kadam, Hyderabad (IN); Ram Krushna Mishra, Hyderabad (IN)

(21) Appl. No.: 18/907,069

(22) Filed: Oct. 4, 2024

(51) Int. Cl. G06F 9/48

(52) U.S. Cl. CPC G06F 9/4881

(57) ABSTRACT

Methods for efficiently performing large sets of computational tasks are provided that include receiving a command to perform a plurality of independent computational tasks within a time period; based on the plurality of independent computational tasks, the time period, and an indication of available computational threads, identifying a subset of the available computational threads; allocating the plurality of independent computational tasks to the subset of the available computational threads, wherein each computational thread of the subset of the available computational threads is allocated a number of the plurality of independent computational tasks; and performing the plurality of independent computational tasks via the subset of the available computational threads in accordance with the allocation. Allocating the tasks non-uniformly across fewer than all of the available computational threads can reduce the power and computational costs to perform the tasks, including allowing the computational threads to efficiently perform other activities.

### BACKGROUND

A variety of applications include tasks to be performed quickly, e.g., time-sensitive tasks. For example, it could be desirable to apply a security update to a large number of computers or other systems quickly, to reduce the possibility that a security vulnerability is taken advantage of on any of the systems prior to their being updated. Where the tasks are relatively independent of one another, there is less constraint on how the tasks are allocated across a number of available computational ‘workers’ (e.g., threads of a multi-threaded processor). So, to perform the tasks as quickly as possible, they could be allocated amongst the available workers equally. However, where the requirement is relaxed such that the tasks are instead completed within a specified time period, a wider variety of possibilities become available for the allocation of tasks amongst available workers and the scheduling of performance of those tasks by the allocated workers. Different allocations and schedules can result in different costs and benefits with respect to overloading of the workers, efficient allocation of the workers between the tasks and other operations, the pattern of changes in the use of the workers in performing the tasks, and/or other considerations. Such a resource allocation can, itself, be computationally complex.

### SUMMARY

A variety of computational processes are characterized in that they are time-sensitive and that they include a number of tasks whose completion is not dependent upon the prior performance of any other of the tasks. For example, installing or otherwise applying a security update to many (e.g., thousands or tens of thousands) computers, smartphones, tablets, servers, or other computational systems. Or, in another example, generating database entries in a database to correspond to a set of computing systems, servers, organizations, or other entities that may be affected by an ongoing event (e.g., a service outage, a data breach) in order to be notified of the event, to submit information (e.g., service requests, status updates) related to the event, to store centrally-generated information related to the event about each of the entities, or to provide some other benefit. In order to perform such time-sensitive tasks in a time-sensitive manner, the tasks can be evenly allocated across a number of available processor threads, processor cores, threads of a cloud computing environment, or other ‘workers’ that are able to perform the tasks. However, such an allocation occupies most or all of the available workers, resulting in a sudden allocation (and eventual de-allocation) of the workers, and other undesirable computational effects. If, instead, the set of tasks are to be completed in less than a maximum period of time, the set of tasks can be scheduled and distributed across the available workers in a more beneficial manner.

The embodiments described herein provide these benefits by allocating, in varying numbers across a subset of the available workers, a set of tasks such that the tasks are all completed within a specified period of time while also reducing various computational costs related to the performance of the tasks by the selected workers. These benefits are obtained by determining, based on (i) the number of tasks to be performed, (ii) the expected time a single worker will take to perform a single one of the tasks, (iii) the number of available workers, and (iv) the specified maximum time to complete all of the tasks, a number of the available workers to allocate to performing the tasks such that the overall computational cost to perform the set of tasks is reduced. Once the subset of workers to allocate to performing the tasks has been determined, the set of tasks can be allocated unequally amongst the allocated workers such that the overall computational cost to perform the set of tasks is reduced. This can include determining a ‘batch size’ of the tasks and then distributing the tasks across the subset of the workers such that each worker in the subset receives a respective multiple of ‘batch sizes’ of the tasks (i.e., such that a first worker receives approximately one ‘batch size’ of the tasks, a second worker receives approximately two ‘batch sizes’ of tasks, etc., up to a final worker receiving approximately the ‘batch size’ times the number of workers in the subset of the tasks.

Allocation of a set of tasks across a subset of available workers in this manner allows the tasks to be performed within a specified maximum time while also reducing the total computational cost to perform the set of tasks. The embodiments herein can also provide other benefits with respect to the ability of a computational system to perform such a set of tasks within a specified maximum time while also efficiently performing other computational tasks. For example, by allocating the performance of respective numbers of the tasks to different allocated workers (e.g., a different number of tasks to each worker), workers to which fewer of the tasks have been allocated can more efficiently schedule when to perform those tasks within the specified maximum time and/or perform the tasks in a less computationally expensive manner.

Accordingly, a first example embodiment may involve: (i) receiving a command to perform a plurality of independent computational tasks within a time period; (ii) based on the plurality of independent computational tasks, the time period, and an indication of available computational threads, identifying a subset of the available computational threads; (iii) allocating the plurality of independent computational tasks to the subset of the available computational threads, wherein each computational thread of the subset of the available computational threads is allocated a respective number of the plurality of independent computational tasks; and (iv) performing the plurality of independent computational tasks via the subset of the available computational threads in accordance with the allocation.

In a second example embodiment, an article of manufacture may include a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A depicts an allocation of tasks across available workers, in accordance with example embodiments.

FIG. 6B depicts an allocation of tasks across available workers, in accordance with example embodiments.

FIG. 6C depicts an allocation of tasks across available workers, in accordance with example embodiments.

FIG. 6D depicts an allocation of tasks across available workers, in accordance with example embodiments.

FIG. 7 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration. ” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is performing a set of independent tasks within a set maximum period of time while reducing the overall computational and/or power cost of performing the set of tasks within a parallel computing environment. In practice, this is problematic because there are many different possible ways to allocate such tasks across available computational threads (or other workers), implicating a significant computational cost in the act of allocating the tasks in addition to any incremental costs related to poor task allocation.

In other techniques, the set of tasks may be evenly allocated across all available computational threads. However, while these techniques perform the tasks in less than the specified maximum time, they do so in a manner that significantly increases the computational, power, or other costs of performing the set of tasks. For example, the amount of power and other computational costs (e.g., memory, bandwidth, database transaction rate) is increased to elevated (e.g. maximal) level for an extended period of time. Additionally, allocating all available workers at once to performing the set of tasks, and then de-allocating those workers at the same time when the tasks complete, can lead to scheduling difficulties and inefficient resource utilization, e.g., as de-allocated workers sit idle waiting for new tasks to be assigned thereto.

The embodiments herein overcome these limitations by determining a subset of available computational threads (e.g., less than all of the available computational threads) to allocate to performing the set of tasks such that the set of tasks is performed within the specified time period, and also by allocating respective numbers of the tasks to each of the allocated computational threads. In this manner, performance of the tasks by the allocated computational threads can be accomplished in a less expensive manner with respect to power and/or computational cost. This results in several advantages. First, the period of time over which the power and computational resources used to perform the tasks is elevated (e.g., to a maximum level) gets reduced by allocating the set of tasks unequally across the computational threads. Second, the level of power or other computational resources used during that elevated period can be reduced by using fewer than all of the available computational threads. Third, computational threads that are allocated fewer of the tasks can perform them more efficiently (e.g., by performing them more slowly, using less memory, or in some other reduced-cost manner) and/or can schedule the performance of the allocated tasks around other computational activities, increasing efficiency, reducing wasted idle processor time/power, or providing other benefits. Fourth, the by allocating respective numbers of the tasks to different computational threads, the timing of starting/ending performance of the tasks by each thread can be staggered, increasing efficiency and reducing processor idle time by reducing the rate at which computational resources are allocated to and away from performance of the tasks.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

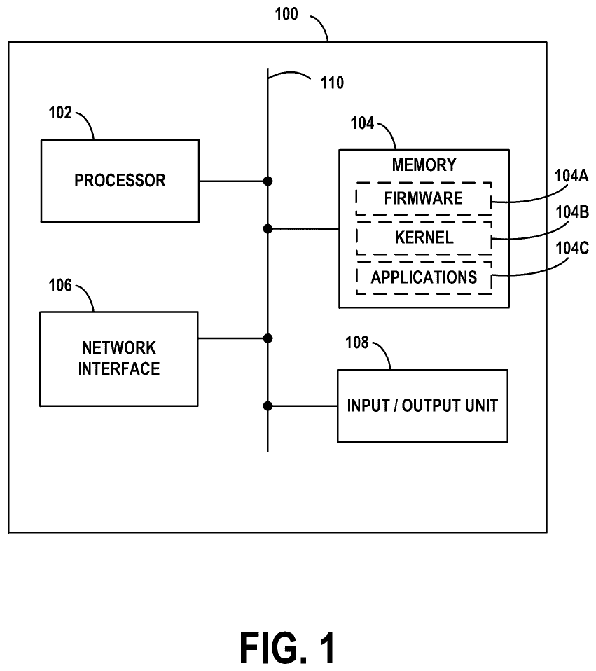

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling, and management of processes, input / output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

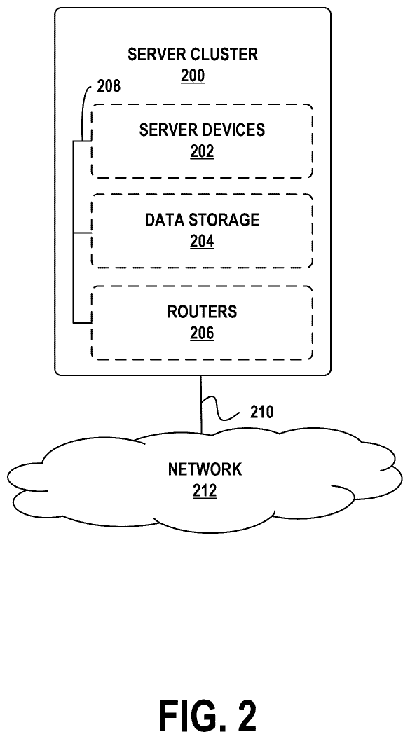

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device. ” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

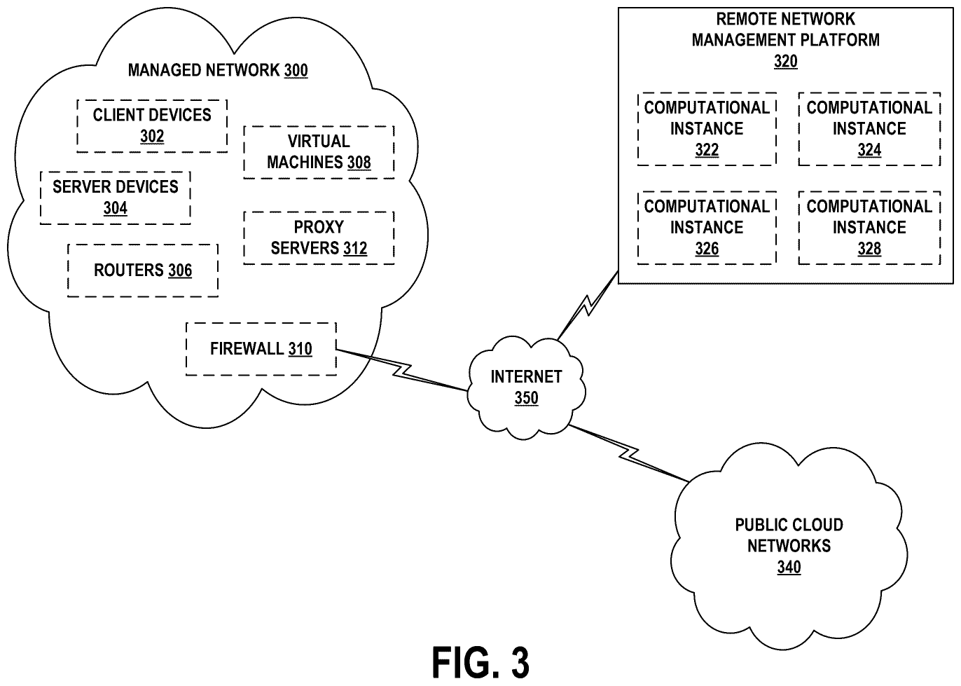

FIG. 3 depicts a remote network management architecture, in accordance with example embodiments. This architecture includes three main components - managed network 300, remote network management platform 320, and public cloud networks 340 - all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance. ” Note that users may colloquially refer to the graphical user interfaces provided thereby as “instances.” But unless it is defined otherwise herein, a “computational instance”is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers'data are separate from one another, the separation is enforced by the software that operates the single database. As a consequence, a security breach in this system may affect all customers'data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

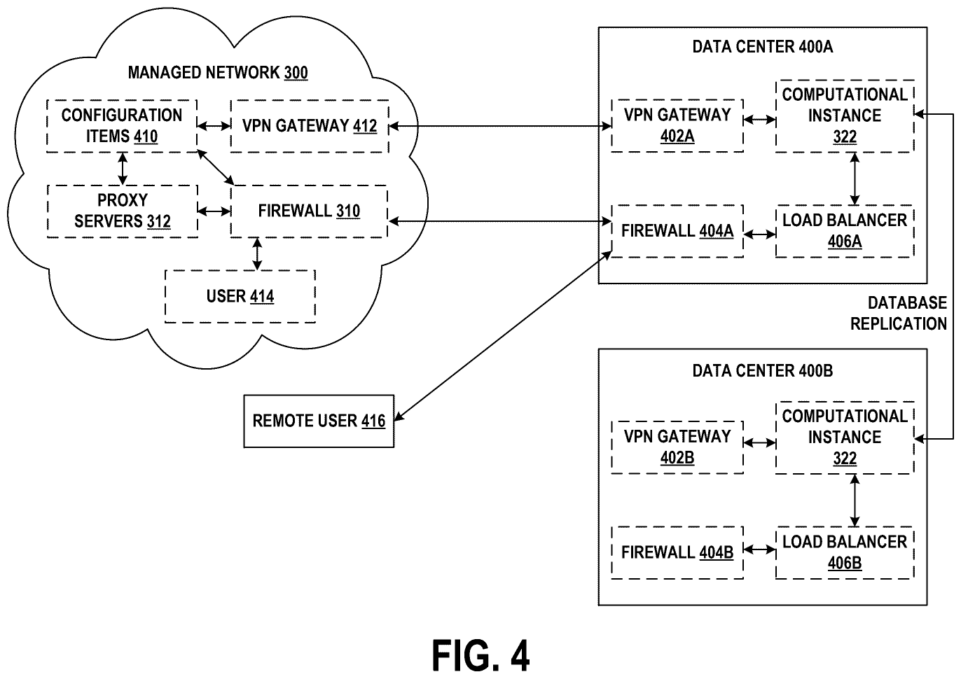

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### V. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

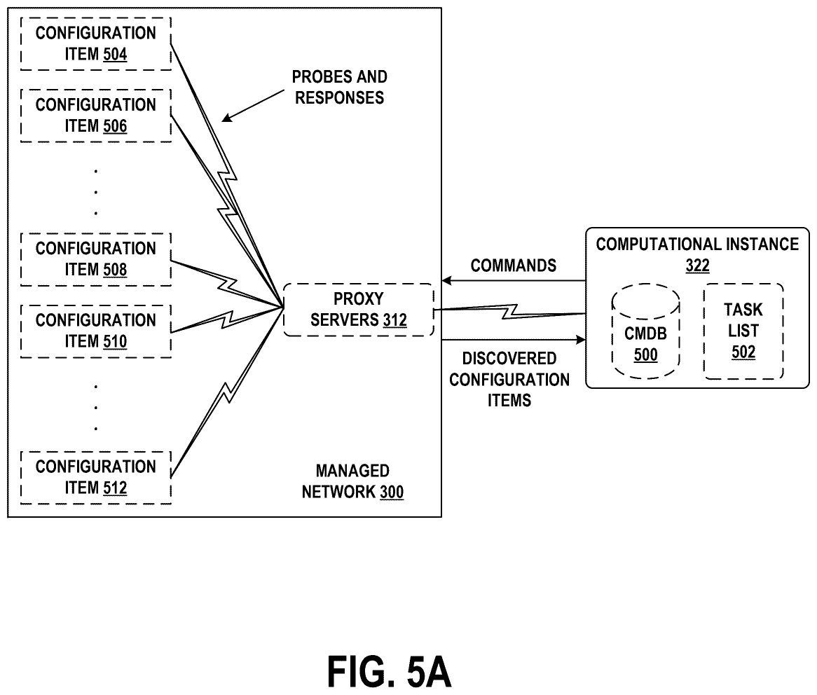

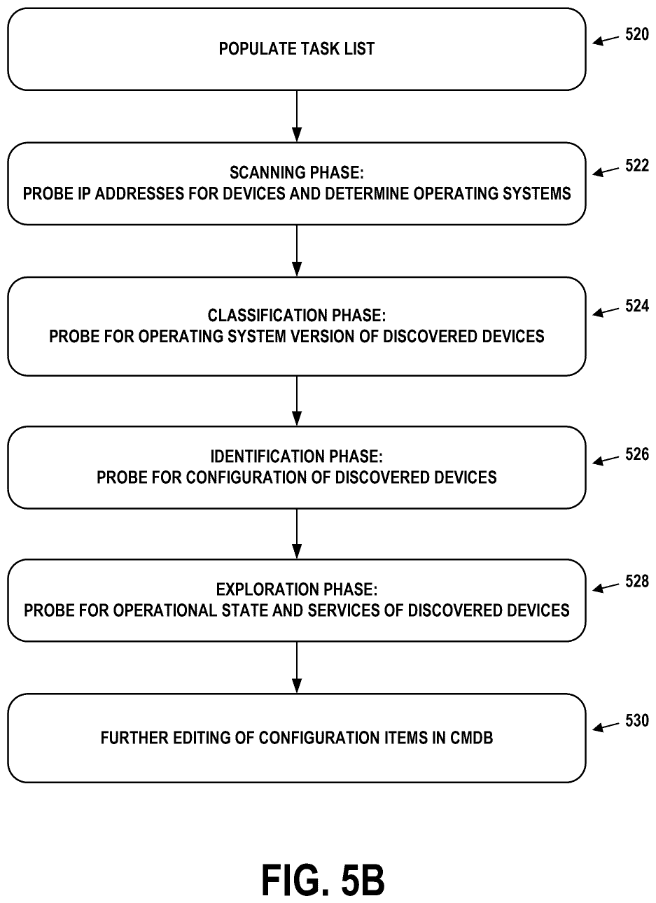

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### VI. Example Improved Allocation of Computational Tasks Among Available Computational Resources

A variety of computational processes are characterized in that they are time-sensitive and that they include a number of tasks whose completion is not dependent upon the prior performance of any other of the tasks. For example, installing or otherwise applying a security update to many (e.g., thousands or tens of thousands) computers, smartphones, tablets, servers, or other computational systems. Or, in another example, generating database entries in a database to correspond to a set of computing systems, servers, organizations, or other entities that may be affected by an ongoing event (e.g., a service outage, a data breach) in order to receive notifications of the event, to submit information (e.g., service requests, status updates) related to the event, to store centrally-generated information related to the event about each of the entities, or to provide some other benefit. In yet another example, bulk upload and import of information (e.g., software and/or hardware configuration information) into a database (e.g., a configuration management database) within a maximum time period in order to reduce the amount of time during which the database cannot be updated or used in some other manner in order to avoid database conflicts, use of obsolete data, or other unwanted effects. In a still further example, scheduled data cleanup (e.g., within a database) to improve needed data retention within a maximum time period in order to reduce the amount of time during which a database or other data store cannot be updated or used in some other manner in order to avoid conflicts, use of obsolete data, or other unwanted effects. In yet another example, collection of KPI metrics or other raw or derived information from a database to perform data analytics quickly, reducing latency to generate such analytics this and improving user experience and allowing the user to repeatedly re-compute the analytics with varying constraints in order to, e.g., obtain improved system functionality by performing additional fine-tuning steps within a set period of time.

Where sufficient computational resources are available to perform the tasks within the specified period of time, the tasks can be allocated amongst the computational resources in a variety of ways. Such computational resources can take the form of processor threads, processor cores, threads of a cloud computing environment, or other types of computational threads (which may be referred to as ‘workers’ elsewhere herein) that are individually able to perform sets of the tasks allocated thereto. Such an allocation problem is complex, and implicates a potential balancing between a variety of different computational costs and considerations in order to, e.g., reduce the total power used by the available computational resources to perform the set of tasks or to provide some other benefit with respect to bandwidth use, efficiency, memory use, or some other computational or other cost or consideration.

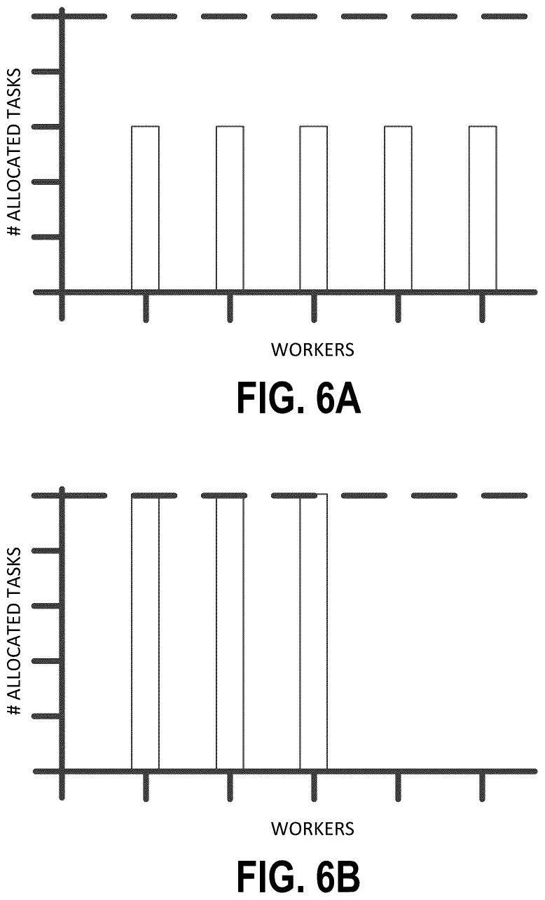

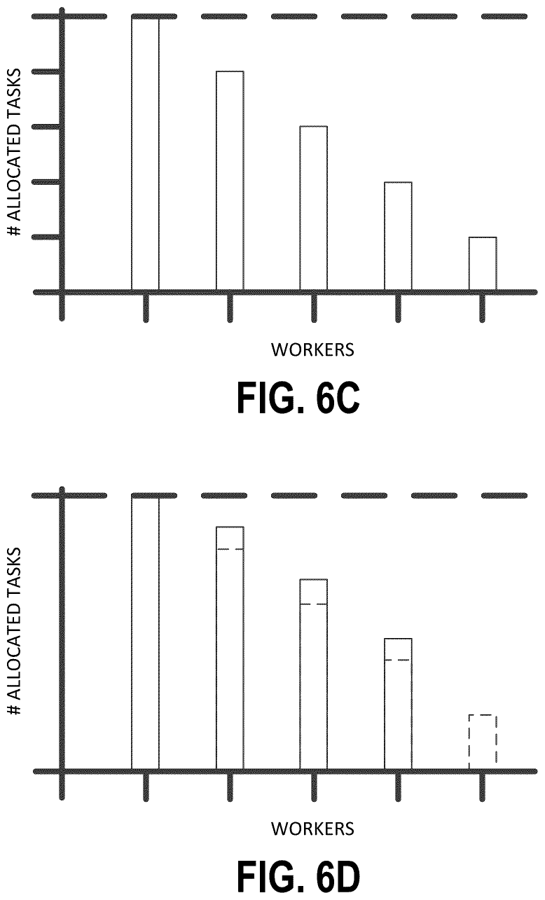

For example, the set of tasks could be naively allocated evenly across a set of available workers. FIG. 6A depicts an example of such an allocation, of 15 tasks across five workers, with each worker receiving an equal number (i.e., three) of the tasks. In such an allocation, the tasks are completed quickly (potentially as quickly as possible, within the constraint of the number of available workers being five), within the maximum permitted time period (indicated in FIGS. 6A-D by the horizontal dashed line). However, where the constraint is merely that the tasks be performed within the maximum time period, performing the tasks in less than that amount of time does not necessarily provide a benefit. Indeed, such an allocation may incur various increased computational and other costs, including increased time over which use of computational resources and power to perform the tasks approaches a maximal level or is otherwise elevated, increased time over which bandwidth or other computational resources are increased (e.g., for all of the workers to transmit commands to or otherwise communicate with a database), increased time over which the rate of database accesses is elevated to the point at which database responsiveness slows, or other increased computational, power, or other costs. Additionally, the use of all of the available workers at the same time could incur increased costs related to the sudden allocation and de-allocation of the workers to the tasks, blocking the performance of any other tasks and potentially leading to reduced efficiency and resource utilization following the completion of the set of tasks as the large set of de-allocated workers wait to have allocated thereto other computational activities. For example, when all available workers are dedicated to a set of compute-heavy or memory-intensive tasks, there may be little computational power or resources remaining for certain user-facing activities, such as user interface display and refreshing. As a result, users may be forced to wait tens of seconds or minutes for their user interfaces to be rendered.

In another example, the set of tasks could be naively allocated evenly across a subset of as few of the available workers can complete the set of task within the specified period of time. FIG. 6B depicts an example of such an allocation, of 15 tasks across three workers, with each worker receiving an equal number (i.e., five) of the tasks. In such an allocation, the identified workers take the entirety of the permitted time period to complete the tasks, with the non-identified workers (the remaining two workers) remaining available to perform other activities, enter a reduced power state, or engage in some other behavior unrelated to the set of tasks. While this allocation is improved relative to the allocation of FIG. 6A in that it exhibits slightly reduced levels of computational resource and power use, decreased levels of bandwidth use, reduced rates of database access, or other improvements with respect to computational, power, or other costs. However, such an allocation still exhibits sudden large-magnitude changes in available workers, thus incurring increased costs related to the sudden allocation and de-allocation of the workers to the tasks, blocking the performance of any other tasks and potentially leading to reduced efficiency and resource utilization following the completion of the set of tasks as the de-allocated workers have new computational activities allocated thereto.

The embodiments described herein lead to improved utilization of available workers (e.g., computational threads or other operational units of computational resources) to perform large numbers of independent tasks within a specified maximum period of time (which may be referred to as an acceptable latency for performance of the set of tasks). These improvements are obtained by employing specific methods for identifying, within an available set of workers, a subset of workers to which to allocate non-overlapping subsets of the tasks. Once the number of workers in the subset is determined, respective subsets of the tasks are allocated to the workers of the subset, with each worker having allocated thereto a respective number of the tasks (e.g., a different number of tasks to each worker). These embodiments provide a variety of benefits, including reducing the period of time during which the amount of power or other computational resources exerted to perform the set of tasks is highly elevated (e.g., to maximal or near-maximal levels), reducing the rate at which workers are allocated to and from performance of the tasks (leading to efficiency and resource utilization to be improved), and allowing workers allocated fewer of the tasks to more efficiently schedule the performance of the tasks within the acceptable latency period.

These embodiments include determining, based on (i) the number of tasks to be performed, (ii) the expected time a single worker will take to perform a single one of the tasks, and (iii) the specified maximum time to complete all of the tasks, a number of the available workers to allocate to performing the tasks such that the overall computational cost to perform the set of tasks is reduced. As noted above, such a determination can result in allocating the tasks across fewer than all of the available workers in order to reduce load and provide other benefits as escribed herein, increasing the ability of the set of available workers to perform the tasks while also efficiently engaging in other computational activities, reducing the amount of power or other computational resources expended to perform the set of tasks, or other benefits. Determining the number of the available workers to which to allocate the set of tasks can include determining the number of workers as ω=┌j/(wτ/t)┐+1 (or a number of workers +/−15%, +/−10%, +/−5%, or otherwise substantially equal to the result of this calculation), where ω is the number of the available workers to use to perform the set of tasks, j is the total number of tasks to be performed, w is the number of available workers, τ is the specified duration of time in which all of the tasks must be completed, and t is the amount of time a single one of the workers takes to perform a single one of the tasks. Such an allocation, which may amount to fewer workers than all of the available workers, allows the set of tasks to be efficiently distributed amongst the subset of the workers in a manner that reduces the total power and other computational costs associated with performing the tasks while still completing all of the tasks within the specified time period τ.

The above worker allocation computation can be performed subsequent to and/or as a result of other preliminary computations. For example, when the number of tasks to be completed is less than a threshold number, there may be insubstantial or no benefit to distributing the tasks across more than one worker. So, in response to determining that the number of tasks is less than that threshold number, a single worker of the available workers could be selected to perform all of the tasks in the set (i.e., all of the tasks in the set could be allocated to the selected single worker). In such an example, a system performing the task allocation could, responsive to determining that only a single worker is to be used to perform the tasks, avoid performing the worker computation above (i.e., ω=┌j/(wτ/t)┐+1), thereby also avoiding the power and computational cost of such a calculation. The threshold value could be determined based on properties of the tasks themselves, e.g., as 2(τ/T) (i.e., if the number of tasks in the set is less than 2(τ/T), all of the tasks will be allocated to a single worker).

Such a computation takes into account the linearly-increasing computational costs associated with distribution of the set of tasks across a number of workers while satisfying a maximum latency criterion, but does not take into account other costs of distributing the tasks across multiple workers. Such costs can include increased memory costs (related to, e.g., tables, configuration settings, or other information that each worker may require locally in order to perform the tasks), bandwidth costs (related to, e.g., multiple workers communicating with a server, database, or other common resource to perform the tasks), database access rate costs, or other costs. Accordingly, a threshold value could be determined (e.g., for a specific server, cloud computing environment, or other distributed multi-worker computational system) such that, if the number of tasks to be performed is less than the threshold value, all of the tasks are allocated to a single worker, thereby resulting in reduced memory use or other computational costs.

Once the number of workers to allocate to performing the tasks has been determined, the set of tasks can be allocated unequally amongst the allocated workers such that the overall computational cost to perform the set of tasks is reduced. This can include determining a ‘batch size’ b as, e.g., b=j/(ω(ω+1)/2) (or a number of tasks +/−15%, +/−10%, +/−5%, or otherwise substantially equal to the result of this calculation), with each of the allocated workers having allocated thereto a respective multiple of b of the tasks. For example, a first one of the workers could be allocated one b of the tasks, and each subsequent worker could be allocated an additional b of the tasks until the final worker is allocated ω*b of the tasks. FIG. 6C depicts an allocation in this manner of fifteen tasks across three workers. In this example, the batch size b is one, so a first worker is allocated one task, a second is allocated two tasks, and so on until the fifth and final worker is allocated five tasks. Alternatively, the tasks could be allocated amongst the subset of workers in some other way to cause differences in the number of tasks allocated to each worker to exactly or approximately (e.g., within 15%, within 10%, within 5%) correspond to multiples of some task increment amount (e.g., a first tasks being allocated N tasks, a second allocated N+c tasks, a third allocated N+2c tasks, etc.). This could be done to allow the rate at which works are allocated to and de-allocated from performance of the set of tasks to be more evenly distributed across the entirety of the specified latency period for performing the tasks and/or to provide some other benefit to the operation of the workers in performing the set of tasks.

Once the number of tasks to allocate to each worker has been determined, the determined number of tasks can be allocated to the workers in a variety of ways. This can include transmitting, to each of the workers, one or more commands identifying the common aspects of the tasks to be performed and an identification of a set of computer systems or other entities for which to perform the tasks and/or some other indication of a manner in which the individuals tasks differ (e.g., as one or more scheduled jobs that can optionally repeat). This could include indicating one or more groups or other sets that include the entities. Additionally or alternatively, allocating the tasks to the workers can include transmitting, to a particular worker, a respective command for each of the tasks allocated to the particular worker.

In some examples, the available workers are distributed across multiple servers, CPUs, GPUs, computers, cloud computing instances, or other multi-worker (e.g., multi-thread) computational nodes. In such examples, there can be computational and/or other costs associated with the use of workers on more than one of the computational nodes. Such costs could be related to spinning up additional instances of a cloud computing environment, to added bandwidth and/or memory costs associated with allocating tasks to workers on multiple different nodes (e.g., bandwidth to transmit information to multiple nodes, memory to store common task information on multiple nodes, memory, power, and cycles to instantiate an interpreter, API, database session, or other infrastructure implicated in performing the tasks), or to some other factor or process that is increased by allocating tasks to workers on multiple different nodes. Accordingly, it can be beneficial to adapt the worker and task allocation methods described herein in order to allocate the set of tasks to workers on a single node (e.g., to a single node, of a set of available nodes, that can provide the most workers). This can include, prior to determining the subset of available workers to which to allocate tasks, comparing the number of the tasks to a threshold value. If the number of tasks is greater than or equal to the threshold value, indicating that cost of using workers across multiple nodes is less than the benefits of using the additional workers available on multiple nodes, then the workers and tasks could be allocated as described above.

If, instead, the number of tasks is less than or equal to the threshold value, indicating that cost of using workers across multiple nodes is greater than the benefits of using the additional workers available on multiple nodes, then the workers and tasks could be allocated as though the workers of a single one of the nodes were the only available workers (e.g., the workers of the node having the most available workers). This could include using the allocating methods above, but under the assumption that the number of available workers W was equal to the number of workers available on a single one of the nodes, rather than the total number of available workers across all of the nodes. This is depicted by way of example, in FIG. 6D, wherein four workers are available on a single node. Allocation of workers independent from the distribution of workers amongst the nodes could result in an allocation of tasks across five of the workers, as shown by the dashed-line allocation, four of the workers on a first node and the final worker on an additional node. However, to avoid the additional costs of allocating tasks to workers on multiple nodes, the tasks could be allocated as though only the four workers of the single node were available, resulting in the solid-line allocation depicted in FIG. 6D.

Allocation of a set of tasks in the manner described herein allows the tasks to be performed within a specified maximum time while also reducing the total computational cost to perform the set of tasks. Such computational costs can include costs with respect to memory use, bandwidth, maximum rate of database calls or use of other computational resources, amount of time that a rate of database calls or use of other computational resources is at or near an elevated or maximal level, maximum power use allocated to performance of the tasks, amount of time that the level of power allocated to performance of the tasks is at or near an elevated or maximum level, or with respect to some other computational cost. The embodiments herein can also provide other benefits with respect to the ability of a computational system to perform such a set of tasks within a specified maximum time while also efficiently performing other computational tasks. For example, by allocating the performance of respective numbers of the tasks to different allocated workers, workers to which fewer of the tasks have been allocated can more efficiently schedule when to perform those tasks within the specified maximum time and/or perform the tasks in a less computationally expensive manner. This could include using lower-priority or fewer database calls, using a lower peak bandwidth to transfer data over a longer period of time, using less memory to perform the tasks in a more efficient but more dilatory manner, or some other beneficial manner of operation facilitated by use of the embodiments described herein.

The embodiments herein were assessed experimentally against conventional task allocation and performance methods for a set of database case creation tasks that include both a preview stage sub-task and a submit stage sub-task. When performing the task to generate 3859 child records in a database, the conventional method took 23 minutes 15 seconds to perform the preview stage and 2 hours 30 minutes to perform the submit stage, while the embodiments described herein took 3 minutes 6 seconds to perform the preview stage and 14 minutes 10 seconds to perform the submit stage, leading to significant time, and accordingly power, savings. When performing the task to generate 238 child records in a database, the conventional method took 11 seconds to perform the preview stage and 9 minutes 47 seconds to perform the submit stage, while the embodiments described herein took 11 seconds to perform the preview stage and 2 minutes 12 seconds to perform the submit stage, leading to significant time, and accordingly power, savings.

In short, the embodiments herein reduce or eliminate bursty task allocations. This results more consistent resource utilization, preventing periods of idleness followed by resource saturation, which can lead to bottlenecks. By distributing tasks more evenly, system components such as processors, memory, and storage can operate at manageable loads, reducing the likelihood of overload from sudden spikes in activity. This also leads to improved response times and reduced latency, as tasks are processed more predictably without overwhelming system queues. Additionally, avoiding burstiness reduces the need for over-provisioning resources, allowing for more efficient use of existing hardware and potentially lowering operational costs. In distributed systems, even task distribution can also improve scalability and fault tolerance, as it helps prevent overload conditions that could cause system failures or degraded performance.

### VII. Example Operations

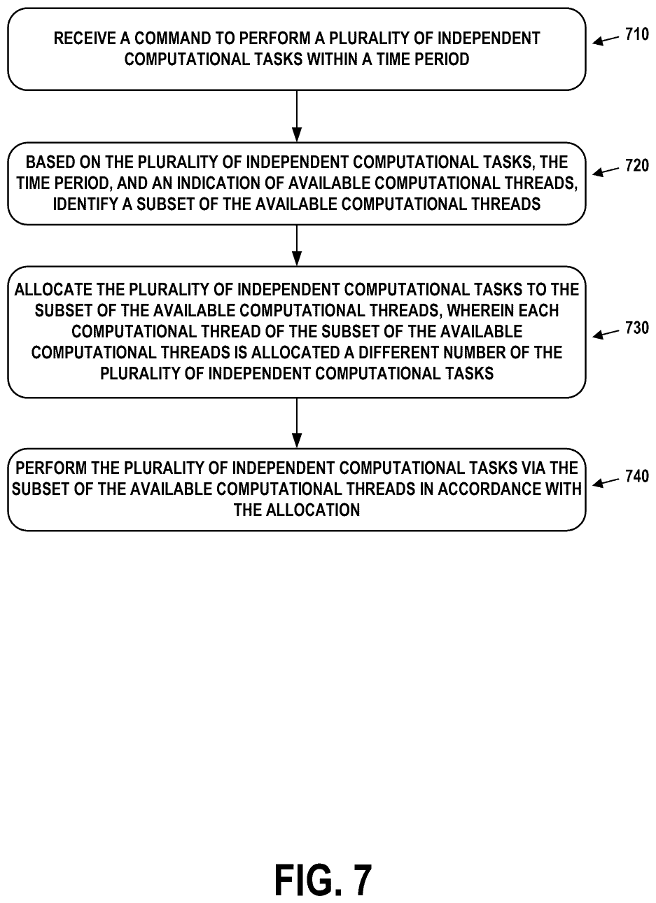

FIG. 7 is a flow chart illustrating an example embodiment. The process illustrated by FIG. 7 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 7 may be simplified by the removal of any one or more of the features shown therein. Further, these embodiments may be combined with features, aspects, and/or implementations of any of the previous figures or otherwise described herein.

The embodiments of FIG. 7 include receiving a command to perform a plurality of independent computational tasks within a time period (710). This could include receiving a command to perform a particular task (e.g., to update a security setting, install a security update, or perform some other update to network security functionality, to generate an entry in a database relating to a service outage or other event) and an indication of a set of computer systems or other entities (e.g., that are associated with a managed network environment) for which/to which to perform the task. Such an indication of the set of computer systems or other entities could include indicating the identities of each of the entities and/or indicating one or more groups or other sets that include the entities.

The embodiments of FIG. 7 additionally include, based on the plurality of independent computational tasks, the time period, and an indication of available computational threads, identifying a subset of the available computational threads (720). This could include evaluating an equation or performing some other computational task to determine a number (e.g., all) of the available computational threads to assign to the subset, e.g., determining a number of computational threads in the subset within 10%, 5%, or some other proportion of ┌J/(Wτ/T)┐+1, wherein J is the number of independent computational tasks in the plurality of independent computational tasks, W is the number of available computational threads, τ is the duration of the time period, and T is an average amount of time a single one of the computational threads takes to perform a single one of the plurality of independent computational tasks. In some examples, if such a determined number exceeds the number of available computational threads, the subset could be determined as all of the available computational threads. In some examples, identifying the subset could include comparing the number of tasks to a threshold value and, if the number of tasks is less than the threshold value, identifying a single computational thread as part of the subset. Such a threshold could be determined based on the number of tasks, e.g., as within 10%, 5%, or some other proportion of 2(τ/T). In some examples, applying an equation (e.g., ┌J/(Wτ/T)┐+1) or performing some other computation to determine a number of the available computational threads to assign to the subset could be performed in response to a determination that the number of tasks exceeds one or more of the above thresholds.

By identifying (720), based on the number of the tasks, the time to complete the tasks, the number of available computational threads, and the specified period of time available to complete the set of tasks, such a specified number of available computational threads (potentially fewer than all of the available computational threads), the set of tasks can be accomplished in a less expensive manner with respect to power and/or computational cost. This is because, among other benefits, such an allocation of available computational threads to performance of the tasks allows the tasks to be performed within the specified time period while also reducing the level of power or other computational resources used by using fewer than all of the available computational threads.

In some examples, the available computational threads could be distributed across two or more computational nodes (e.g., servers, GPUs, CPUs, instances of a cloud computing or other distributed computing environment). In such examples, the number of tasks to be performed could be compared to a threshold value and, in response to the number of tasks being less than the threshold value, the subset of computational threads could be determined as though the number of available computational threads was the number of available computational threads on a single one of the computational nodes (e.g., the node having the greatest number of computational threads). This has the benefit of reducing the memory used or other computational costs attendant on splitting the set of tasks across multiple nodes while still accomplishing the set of tasks within the specified period of time.

The embodiments of FIG. 7 further include allocating the plurality of independent computational tasks to the subset of the available computational threads, wherein each computational thread of the subset of the available computational threads is allocated a respective number of the plurality of independent computational tasks (730). This could include allocating the plurality of tasks amongst the subset of computational threads such that each thread is allocated a respective number of tasks. The number of tasks allocated to each thread of the subset could be determined such that each thread is allocated a respective different multiple (or within 15%, 10%, 5%, etc.) of a task batch size. Such a task batch size could be determined by evaluating an equation or performing some other computational task to determine a number (e.g., all) of the computational tasks to allocate with each task batch size, e.g., within 10%, 5%, or some other proportion of J/(ω(ω+1)/2), wherein ω is the number of computational threads in the subset. When such a task batch size is used, each computational thread in the subset could receive a respective incrementing multiple of the task batch size, e.g., a first thread could be allocated one task batch size of the tasks, a second thread could be allocated two task batch sizes of the tasks, up to a final computational thread being allocated as many task batch sizes of the tasks as the number of threads in the subset.

By allocating (730) the tasks unequally across the subset of computational threads in such a manner (e.g., such that the number of tasks allocated to each thread is incremented by a batch size or other regular amount across the threads), the set of tasks can be accomplished in a less expensive manner with respect to power, computational cost, or other factors. This is because, among other benefits, such an unequal allocation of tasks across a set of computational threads reduces the period of time over which the power and computational resources used to perform the tasks is elevated. This also allows threads allocated fewer tasks to perform the tasks more efficiently (e.g., by performing them more slowly, using less memory, or in some other reduced-cost manner) and/or to schedule the performance of the allocated tasks around other computational activities, increasing efficiency, reducing wasted idle processor time/power, or providing other benefits. Additionally, by allocating respective numbers of the tasks to different computational threads, the timing of starting/ending performance of the tasks by each thread can be staggered, increasing efficiency and reducing processor idle time by reducing the rate at which computational resources are allocated to and away from performance of the tasks.

The embodiments of FIG. 7 additionally include performing the plurality of independent computational tasks via the subset of the available computational threads in accordance with the allocation (740).

### VIII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving a command to perform a plurality of independent computational tasks within a time period;
based on the plurality of independent computational tasks, the time period, and an indication of available computational threads, identifying a subset of the available computational threads;
allocating the plurality of independent computational tasks to the subset of the available computational threads, wherein each computational thread of the subset of the available computational threads is allocated a respective number of the plurality of independent computational tasks; and
performing the plurality of independent computational tasks via the subset of the available computational threads in accordance with the allocation.

2. The method of claim 1, wherein identifying the subset of the available computational threads comprises determining a number of computational threads in the subset within 10% of ┌J/(Wτ/T)┐+1, wherein J is the number of independent computational tasks in the plurality of independent computational tasks, W is the number of available computational threads, τ is the duration of the time period, and T is an average amount of time a single one of the computational threads takes to perform a single one of the plurality of independent computational tasks.

3. The method of claim 2, wherein allocating the plurality of independent computational tasks to the subset of the available computational threads comprises:
determining a task batch size within 10% of J/(ω(ω+1)/2), wherein ω is the number of computational threads in the subset; and
allocating, to each computational thread in the subset, a respective multiple of the task batch size of the plurality of independent computational tasks.

4. The method of claim 2, wherein determining the number of computational threads is performed responsive to determining that the number of independent computational tasks in the plurality of independent computational tasks is greater than a threshold number of tasks.

5. The method of claim 2, wherein determining the number of computational threads
comprises determining the number of computational threads in the subset within 5% of ┌J/(Wτ/T)┐+1.

6. The method of claim 2, wherein determining the number of computational threads is performed responsive to determining that the number of independent computational tasks in the plurality of independent computational tasks is greater than 2(τ/T).

7. The method of claim 1, wherein identifying the subset of the available computational threads comprises:
determining a target number of computational threads in the subset within 10% of ┌J/(Wτ/T)┐+1, wherein J is the number of independent computational tasks in the plurality of independent computational tasks, W is the number of available computational threads, τ is the duration of the time period, and T is an average amount of time a single one of the computational threads takes to perform a single one of the plurality of independent computational tasks;
determining that the target number of computational threads exceeds the number of available computational threads; and
responsively identifying the subset of the available computational threads as all of the available computational threads.

8. The method of claim 1, wherein identifying the subset of the available computational threads comprises:
determining that the number of independent computational tasks in the plurality of independent computational tasks is less than a threshold value, wherein the threshold value is within 10% of 2(τ/T); and
responsively identifying the subset of the available computational threads as a single one of the available computational threads.

9. The method of claim 1, wherein allocating the plurality of independent computational tasks to the subset of the available computational threads comprises:
determining a task batch size within 10% of J/(ω(ω+1)/2), wherein ω is the number of computational threads in the subset; and
allocating, to each computational thread in the subset, a respective multiple of the task batch size of the plurality of independent computational tasks.

10. The method of claim 1, wherein the available computational threads are distributed across two or more computational nodes, wherein identifying the subset of the available computational threads based on the plurality of independent computational tasks, the time period, and the indication of available computational threads is performed responsive to determining that the number of independent computational tasks in the plurality of independent computational tasks is greater than a threshold number of tasks, and wherein the method further comprises:
receiving an additional command to perform an additional plurality of independent computational tasks within an additional time period;
determining that the number of independent computational tasks in the additional plurality of independent computational tasks is less than the threshold number of tasks;
responsively identifying an additional subset of the available computational threads based on the additional plurality of independent computational tasks, the additional time period, and a number of available computational threads within a single one of the two or more computational nodes;
allocating the additional plurality of independent computational tasks to the additional subset of the available computational threads, wherein each computational thread of the additional subset of the available computational threads is allocated a respective number of the additional plurality of independent computational tasks; and
performing the additional plurality of independent computational tasks via the additional subset of the available computational threads in accordance with the allocation.

11. The method of claim 1, wherein the plurality of independent computational tasks comprise tasks to create, within a database, respective database entries about an event for respective entities associated with a managed network environment.

12. The method of claim 1, wherein the plurality of independent computational tasks comprise tasks to update a network security functionality of respective computer systems of a managed network environment.

13. The method of claim 1, wherein the plurality of computational tasks are sufficiently independent of each other such that performance of a given one of the computational tasks is not dependent on completed performance of any other of the computational tasks.

14. A system comprising:
at least one processor; and
a memory in which are stored program instructions that, upon execution by the at least one processor, cause the at least on processor to perform operations comprising:
receiving a command to perform a plurality of independent computational tasks within a time period;
based on the plurality of independent computational tasks, the time period, and an indication of available computational threads, identifying a subset of the available computational threads;
allocating the plurality of independent computational tasks to the subset of the available computational threads, wherein each computational thread of the subset of the available computational threads is allocated a respective number of the plurality of independent computational tasks; and
performing the plurality of independent computational tasks via the subset of the available computational threads in accordance with the allocation.

15. The system of claim 14, wherein identifying the subset of the available computational threads comprises determining a number of computational threads in the subset within 10% of ┌J/(Wτ/T)┐+1, wherein J is the number of independent computational tasks in the plurality of independent computational tasks, W is the number of available computational threads, τ is the duration of the time period, and T is an average amount of time a single one of the computational threads takes to perform a single one of the plurality of independent computational tasks.

16. The system of claim 15, wherein allocating the plurality of independent computational tasks to the subset of the available computational threads comprises:
determining a task batch size within 10% of J/(ω(ω+1)/2), wherein ω is the number of computational threads in the subset; and
allocating, to each computational thread in the subset, a respective multiple of the task batch size of the plurality of independent computational tasks.

17. The system of claim 15, wherein determining the number of computational threads is performed responsive to determining that the number of independent computational tasks in the plurality of independent computational tasks is greater than 2(τ/T).

18. An article of manufacture including a non-transitory computer-readable medium, having stored thereon program instructions that, upon execution by a computing system, cause the computing system to perform operations comprising:
receiving a command to perform a plurality of independent computational tasks within a time period;
based on the plurality of independent computational tasks, the time period, and an indication of available computational threads, identifying a subset of the available computational threads;
allocating the plurality of independent computational tasks to the subset of the available computational threads, wherein each computational thread of the subset of the available computational threads is allocated a respective number of the plurality of independent computational tasks; and
performing the plurality of independent computational tasks via the subset of the available computational threads in accordance with the allocation.

19. The system of claim 18, wherein identifying the subset of the available computational threads comprises determining a number of computational threads in the subset within 10% of ┌J/(Wτ/T)┐+1, wherein J is the number of independent computational tasks in the plurality of independent computational tasks, W is the number of available computational threads, τ is the duration of the time period, and T is an average amount of time a single one of the computational threads takes to perform a single one of the plurality of independent computational tasks.

20. The system of claim 19, wherein allocating the plurality of independent computational tasks to the subset of the available computational threads comprises:
determining a task batch size within 10% of J/(ω(ω+1)/2), wherein ω is the number of computational threads in the subset; and
allocating, to each computational thread in the subset, a respective multiple of the task batch size of the plurality of independent computational tasks.
